(19) United States
(12) Patent Application Publication
(10) Pub. No.: US 2022/0060522 A1
(43) Pub. Date: Feb. 24, 2022

(54) Touch Reduction Conferencing System and Method

(71) Applicant: David Bawarsky, Fort Lauderdale, FL (US)

(72) Inventor: David Bawarsky, Fort Lauderdale, FL (US)

(21) Appl. No.: 17/445,389

(22) Filed: Aug. 18, 2021

Related U.S. Application Data
(60) Provisional application No. 63/067,528, filed on Aug. 19, 2020.

(51) Int. Cl. H04L 29/06

(52) U.S. Cl. CPC H04L 65/1069; G06F 3/0482; H04L 65/403

(57) ABSTRACT

System and methods for touch reduction conferencing are provided. The system, for example, includes an input/output device remote from a first-user and a processor. The processor programmed to: receive an input from the first-user at the processor, the input including a request from the first user for a meeting with a second-user; deliver an output at the input/output device, the output including the request sent to at least one of the second-user and an administrator; deliver an output from the processor, the output including confirming the meeting to the first-user and at least one of the second-user and the administrator; and deliver an output at the input/ouput device, the ouput including connecting the first-user with the second-user at the meeting without at least one of the second-user and the administrator interacting with the input/ouput device.

### BACKGROUND

Managing exposure levels to potential contaminates in social situations is a growing problem. Mitigating health issues by various means are therefore under consideration.

### SUMMARY

System and methods for touch reduction conferencing are provided. The system, for example, includes an input/output device remote from a first-user and a processor. The processor programmed to: receive an input from the first-user at the processor, the input including a request from the first user for a meeting with a second-user; deliver an output at the input/output device, the output including the request sent to at least one of the second-user and an administrator; deliver an output from the processor, the output including confirming the meeting to the first-user and at least one of the second-user and the administrator; and deliver an output at the input/ouput device, the ouput including connecting the first-user with the second-user at the meeting without at least one of the second-user and the administrator interacting with the input/ouput device.

### BRIEF DESCRIPTION OF THE DRAWINGS

FIG. 1 is a schematic block diagram of a system in accordance with the embodiments.

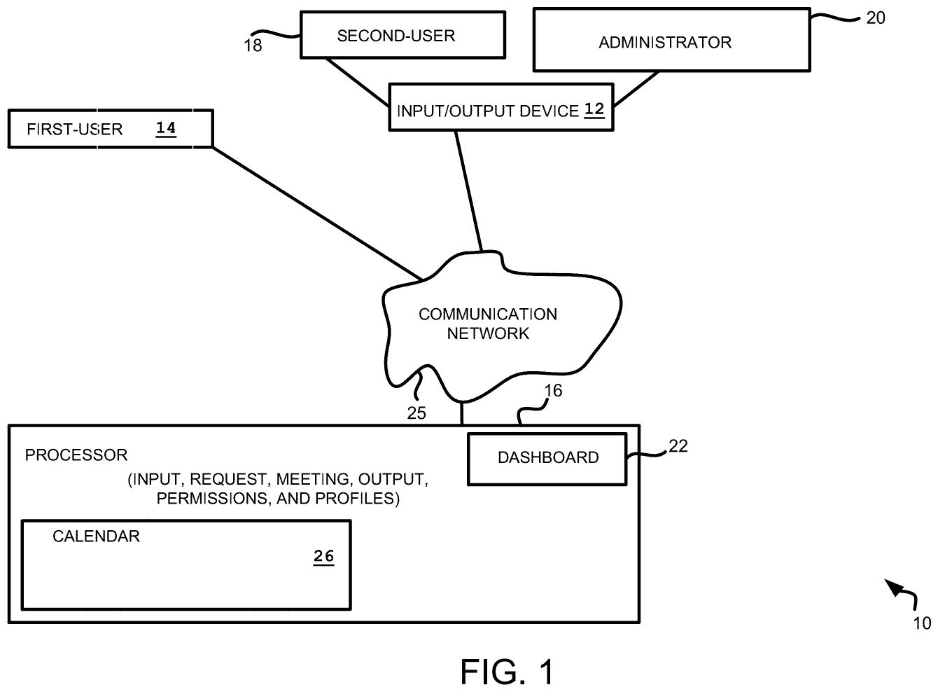

FIG. 2 is a flowchart illustrating method aspects according to various embodiments.

FIG. 3 is a flowchart illustrating method aspects according to the method of FIG. 2.

FIG. 4 is a flowchart illustrating method aspects according to the method of FIG. 2.

FIG. 5 is one embodiment of the input/output device according to the system of FIG. 1.

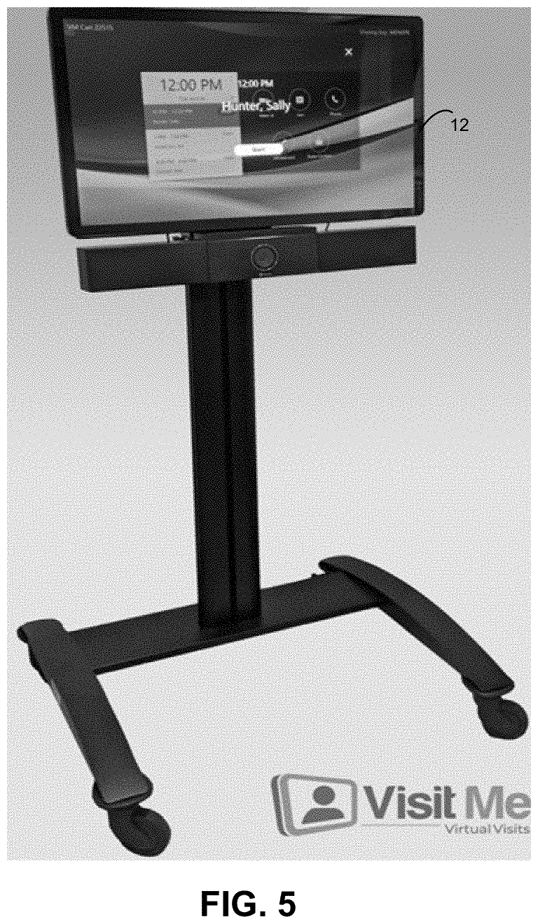

### DETAILED DESCRIPTION

The following detailed description describes techniques (e.g., methods, processes, and systems) for touch reduction conferencing are provided. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims.

In general, System and methods for touch reduction conferencing are provided. In one embodiment the system 10 includes an input/output device 12 remote from a first-user 14, e.g. visitor, and a processor 16. In other words, the first-user 14 cannot physically touch the input/ouput device 12. The processor 16 is programmed to receive an input from the first-user 14 at the processor, the input including a request from the first user for a meeting with a second-user 18. The system 10 further delivers an output at the input/output device 12, the output including the request sent to at least one of the second-user 18, e.g. resident, and an administrator 20, e.g. employee of the facility and/or manager of system 10. The system 10 also delivers an output from the processor 16, the output including confirming the meeting to the first-user 14 and at least one of the second-user 18 and the administrator 20. The system 10 additionally delivers an output at the input/ouput device 12, the ouput including connecting the first-user 14 with the second-user 18 at the meeting without at least one of the second-user and the administrator interacting with the input/ouput device.

In one embodiment, the meeting is a video conference. In another embodiment the meeting is an audio conference. In another embodiment the meeting is a text/graphics based conference.

In one embodiment, the processor 16 includes a dashboard 22 accessible by at least one of the first-user 14, the second-user 18, and the administrator 20, and each one of the at least one of the first-user, the second-user, and the administrator access the dashboard according to the permissions granted for each. In other words,the first-user 14, the second-user 18, and the administrator 20 use the dashboard as an interface to the system 10 and are limited in their access within system 10 according to the permissions granted each party.

In another embodiment, the dashboard includes profiles 24 setup for the first-user 14, the second-user 18, and the administrator 20 which defines the permissions granted to each. Stated another way, the profiles identify each of the first-user 14, the second-user 18, and the administrator 20 to the processor 16.

In one embodiment, the input/out device 12 used by at least one of the second-user 18 and the administrator 20 is remote from the processor 16. In another embodiment the input/output device 12 and the processor 16 are in close enough physical proximity of each other that a user could walk between the two in less than 30 minutes. In another embodiment the the input/output device 12 and the process 16 are only in data communication with one another.

In one embodiment the input/out device 12 is used by at least one of the second-user 18 and the administrator 20 to request a meeting with the first-user 14 with either the second-user and the administrator. Stated another way, the first-user 14 can be contacted through system 10 by the second-user 18 and/or the administrator 20.

In another embodiment, the processor 16 includes a calendar 26 used to organize the meeting between the first-user 14 and the second-user 18. The calendar includes days, weeks, months, years and any time increment within thoses in order to schedule the meeting between any of the parties.

In one embodiment, the meeting starts and finishes without contact between the input/ouput device 12 and at least one of the second-user 18 the administrator 20. In other words, by removing having to touch the input/output device 12, greater sanitation is provided to each of the the second-user 18 and the administrator 20.

In one embodiment, the system 10 communicates over a communications network 25, which enables a signal to travel anywhere within system 10 and/or to any other component/system connected to system 10. The communications network 25 is wired and/or wireless, for example. The communications network 25 is local and/or global with respect to system 10, for instance.

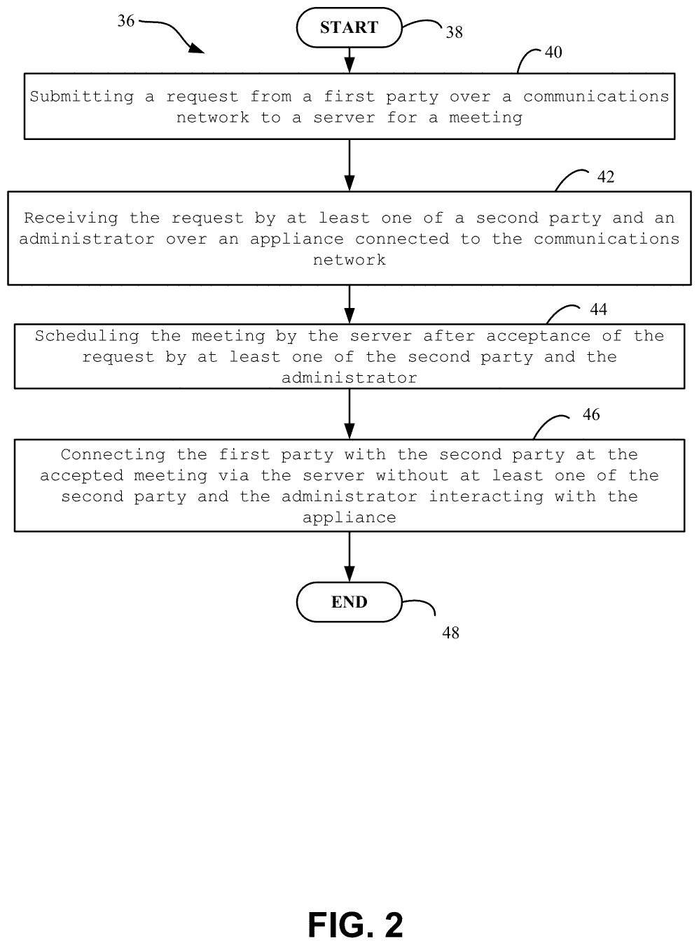

Another aspect is a method of for touch reduction conferencing, which is now described with reference to flowchart 36 of FIG. 2. The method begins at Block 38 and may include submitting a request from a first party over a communications network to a server for a meeting at Block 40. The method may also include receiving the request by at least one of a second party and an administrator over an appliance connected to the communications network at Block 42. The method may further include scheduling the meeting by the server after acceptance of the request by at least one of the second party and the administrator at Block 44. The method may additionally include connecting the first party with the second party at the accepted meeting via the server without at least one of the second party and the administrator interacting with the appliance at Block 46 The method ends at Block 48.

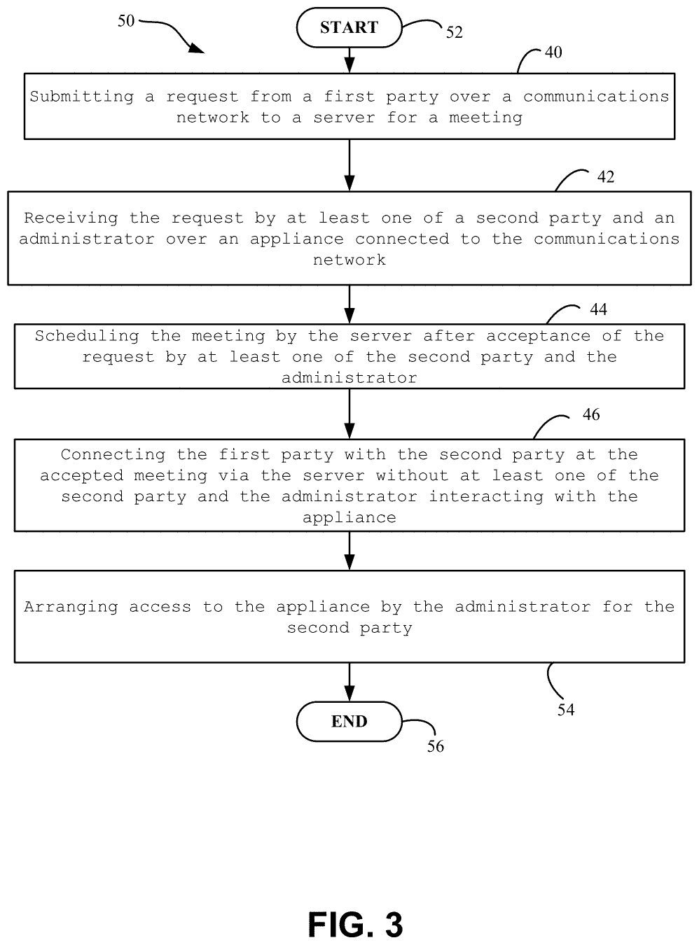

In another method embodiment, which is now described with reference to flowchart 50 of FIG. 3, the method begins at Block 52. The method may include the steps of FIG. 2 at Blocks 40-46. The method may also include arranging access to the appliance by the administrator for the second party at Block 54. The method ends at Block 56.

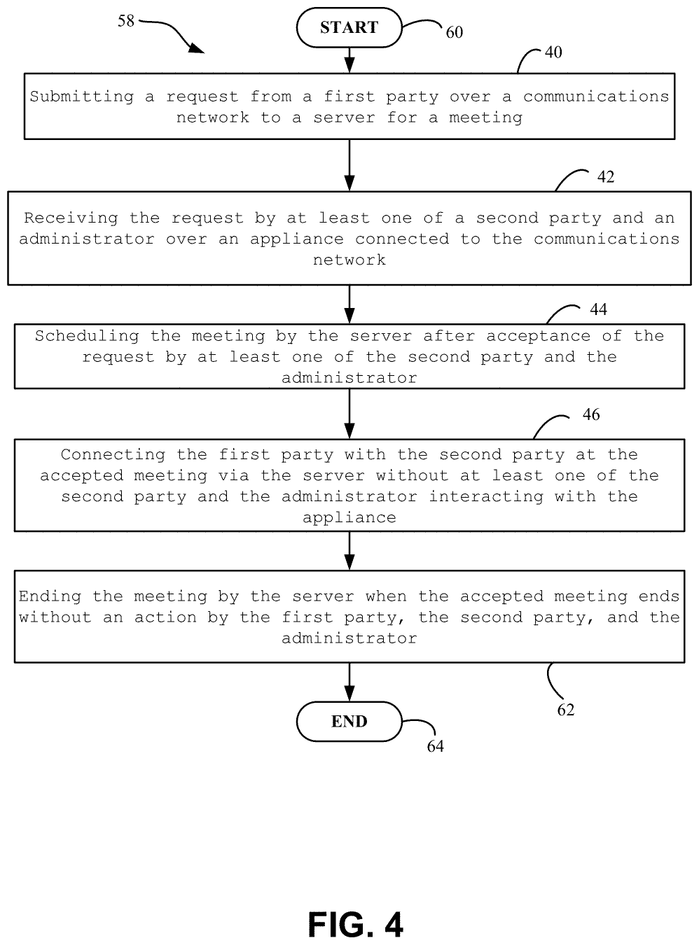

In another method embodiment, which is now described with reference to flowchart 58 of FIG. 4, the method begins at Block 60. The method may include the steps of FIG. 2 at Blocks 40-46. The method may also include ending the meeting by the server when the accepted meeting ends without an action by the first party, the second party, and the administrator at Block 62. The method ends at Block 64.

During the Covid-19 pandemic of 2020, assisted living facilities, hospitals, rehab centers, long-term care, and nursing homes were locked down. Family members and loved ones who resided at these facilities were not allowed to have any visitors. Many of these residents had died during this pandemic. Many family members and loved ones did not get a chance to say goodbye. Some family members took things in their own hands and risked injuries to themselves to peer through windows to see their loved ones.

Unfortunately, many of these facilities did not have the technology and infrastructure to allow Virtual Visits. There was no simple solution to provide an organized way to connect with family and loved ones through video conferencing.

The CDS (Centers for Disease Control and Prevention) imposed guidelines for these facilities to limit and, in many cases, avoid visitors. As a result, some facilities tried using phones and tablet video conferencing technology to try to offer virtual visits for their patients and residents. Unfortunately, there was no cohesive, simple way to coordinate and connect through video conferencing. Many Facilities' employees and/or staff were not tech-savvy and did not have the right equipment nor the time to organize virtual visits. Coordination involves time, emails, and phone calls to schedule just one meeting between the Visitor and Resident.

As some Facilities tried to use phones and tablets, Residents did not hold the phone or tablet correctly or have it adequately disinfected after use. Sound levels on most of these devices (phones/tablets) were not loud enough, especially for the hard of hearing residents. And in many cases, the video screens were tiny and hard for the elderly to see. Many of the video calls ended up skipping and stopped frequently. Not enjoyable for virtual visits. There were no simple solutions to schedule and fully automate the process of virtual visits.

The system 10, Visit Me TV, is a personalized video calling service, empowering family, and friends to virtually visit loved ones who are residing in, but not limited to, assisted living facilities, hospitals, rehab centers, long-term care, nursing homes, prisons, jails, and/or the like.

System 10, Visit Me TV, provides a simple, automated solution for scheduling, managing, and hosting Virtual Visits.

Family and friends can schedule appointments online for a virtual visit with a few simple clicks after they first register.

Once registered, they can schedule virtual visiting appointments through a Dashboard. When a virtual visit appointment gets scheduled, auto email and/or text confirmations are sent to the Visitor and to the Facility where the Resident is residing.

Visitors can also invite others to participate in the scheduled visit. When they invite others, the invitees receive an automated email with a link to join at the scheduled time. The number of attendees is limited to the specific video conferencing platform's limitations. Most have limits from 100-400 attendees.

As a virtual visit appointment approaches, a “Visit Me TV Cart” is wheeled into the residents' room, or the Resident goes to the Visit Me Cart. At the scheduled time, the Virtual Visit automatically begins, and the Visitor is seen on the TV display screen. The Cart's video camera frames any Resident's position: lying in bed, sitting in a wheelchair, sitting on a chair or sofa, or standing.

The visit automatically ends at a pre-scheduled time, and the “Visit Me TV Cart” becomes available for the next scheduled visit. The visits can also stop at any time before the scheduled end-time with one-click. The virtual visits are completely touchless for the Resident.

Once the Facility configures the initial Visit Me Software setup, Visit Me requires minimal involvement from the Facility. The Visit Me Carts and the Visit Me Software automate the process from scheduling through the actual virtual visit. The software syncs with a Visit Me Cart, allowing for the visit to start automatically at the scheduled time. The Cart's equipment and the display enable the Resident to see and talk to the Visitor(s), while Visitors use their smartphone, tablet, or computer to communicate.

A registered Visitor can also have family and friends residing in other non-related facilities, linked to their Dashboard for people to visit. Once a Visitor links a resident, they can schedule visits with anyone in any facility, connected to the Visit Me TV network.

### Visit Me Carts

A Visit Me Cart is an audio/video system capable of providing video conferencing from popular video conferencing platforms, including Zoom, Go-to-Room, and WebEx. Visit Me Carts can be mobile or stationary.

Visit Me Carts include, but not limited to:

1. Touchscreen Display

2. 4KCamera(s)

3. Audio Speaker(s)

4. Microphone(s)

5. Wired/Wireless Online Access

6. 1080p/4K 30 fps (frames per second) minimum output

7. API connectivity

8. PC

Visitors log into the virtual meeting with a unique link they receive by an auto email after scheduling. Each Visitor communicates through their smartphone, tablet, or computer during the virtual visit.

### The Visit Me TV Software

Each Facility needs at least one certified Visit Me Cart and the Visit Me SaaS (software-as-a-service) to automate the scheduling, managing, carts settings, and virtual visits The Visit Me software is accessed through a cloud server. The Facilities' Visit Me Carts are connected and synced through an API (application programming interface) to provide a fully automated system to visit anyone on the Visit Me TV network virtually. Facilities can have an unlimited number of carts to use for visits.

The system 10's software allows the Facility's visitors to schedule their virtual visits online. The Facility sets the virtual visiting days and hours. After first registering once, virtual visitors have a Dashboard to schedule and manage their Visits. It takes less than ten seconds to schedule a virtual visit.

### Saab Features

### Admin User:

The advantage of the online Admin Section is to have an easy way for facilities to manage their Visitor Carts and Visitors. The admin dashboard is an easy way to check and manage visits, manage residents, add Admin users, set Virtual Visiting hours and days, send email invites to visitor requests, and manage Visitor Carts settings and usage.
1. Facilities go to the login of the Admin Dashboard.
2. Enter email and password.
3. Click “log in” to enter.
4. If forgot password, send an email to reset.
5. Once logged in, the user has access to their Admin Dashboard.

### Admin Dashboard:

The online Admin Dashboard shows an overview of upcoming visits for the day, quick buttons for; adding residents, alerts, pending invites, cancel visits, and today's visits,
1. Click on an upcoming visitor to receive more information about the Visitor; photo, name, phone number, email, and relationship to Resident.
2. Click “email Icon” to send a quick email to Visitor
3. Click “Settings” to see all the setting tabs; Residents, Visitors, Bookings, Carts, Other Settings
4. Click “log out” to log out of Dashboard

### The “Settings” Tabs:

Settings Tabs is for the management of the software, Visitor Carts, and Virtual Visits. The tabs include; add Resident, manage resident, list of registered visitors, upcoming visits, cart info, visiting hours, and duration settings.

### To “Add Resident”:

Clicking on Add Resident goes to an overview page of the Resident.
1. Click “Add”
2. Enter the “First Name”
3. Enter the “Last Name”
4. Enter a “Visitor ID Number”
5. Add “Photo” of Resident
6. Click “Visitor Invites” to send email Invites to Visitors
7. Enter Visitor's first name, last name, email address—submit
8. See List of open “Pending Invites” (email Invites that haven't been registered yet)
9. Click “Visitor” to see list of all registered visitors for Resident
10. Click “Bookings” to see list of all upcoming visits for Resident
11. Click “Remove” to remove Resident

### Selecting the Resident's “Visiting Cart Number”

1. In “Resident Tab”, click on the “Manage” button for the Resident.
2. Select a “Cart Number” from the drop-down menu.
   This assigns the cart to the Resident for their Virtual Visits. Facilities can change the Resident's Cart Number at any time.

### The “Visitor” Tab:

The Visitor Tab shows a list of registered and pending visitors, current status, and date registered. Any pending invites will be listed with a “resend invite” to resend the email. It also allows for changing the email address.
1. Click on a Visitor or Search Name to see more additional information about the Visitor.
2. Click email to send an email

### The “Upcoming Visits” Tab:

The Upcoming Visits Tab is an overview listing of the upcoming Residents Visitors showing: date, time, Resident visiting, and visitor cart number.
1. Click on “Resident Name” to go to the “Resident Information Page” showing information about the Resident
2. Click on “Visitor Name” to see pop up of information about the Visitor: email, phone number, and relationship to Resident
3. Click on “email icon” to send a quick email to the Visitor
4. Click to “Cancel Visit”
5. Type reason for the cancellation
6. Click “Confirm Cancellation”
7. Emails are automatically sent to the Visitor and Facility announcing the cancellation

### The “Carts” Tab:

Clicking on the Carts Tab shows an overview of each carts current status of each Cart; cart number, time zone, current status and number of upcoming visits

### The “Settings” Tab:

Clicking on the settings tab allows the user to set the visiting days, hours, and visit duration.

### Visitors:

Anyone who wishes to virtual visit a resident must first register. Once the Visitor becomes registered, the Visitor has access to a dashboard to; link to a resident for visiting, see all residents linked, listing upcoming visits, and profile information. The Visitor can schedule multiple visits for many months out.

### Registering a “Visitor”:

A visitor who wants to virtually visit a Resident must do a one-time registration using one of two ways:
1. Know the “Resident's ID number” and go online to visitme.tv to register.
2. Received an “Invite” email from the Facility and click on a link to register page.

Once registered, they have access to a dashboard.

### The “Visitor” Dashboard:

The Visitor Dashboard is a quick and easy for Visitors to manage, schedule, and invite others to the visit. It takes less than 10 second to schedule a visit.

### To “Schedule a Visit”:

1. On the “Family & Friends” tab, click on the Resident you wish to visit from your Resident visiting list.
2. The “Calendar” for the Resident is displayed.
3. Select the “Month and Day” of the requested visit.
4. Select the “Time” for the visit.
5. Click “Confirm” to book that day and time.
6. An auto email confirmation gets sent to Visitor.
7. A second auto email is sent shortly after confirming the visit, which includes the link to the virtual visit. An auto email is also sent to the Resident's Facility.
8. At the scheduled day and time, the assigned Visit Me Cart will automatically start the visit and automatically end the visit.

### My “Upcoming Visits” Tab:

“My Upcoming Visits” shows all upcoming visits. It allows the Visitor to invite others to the visit, cancel the appointment, and start the visit.
1. To invite others, click on “Invite Others.”
2. Enter the email address to send the invite
3. Click “Send Invite”
4. Click on “Cancel” to cancel the visit
5. Click on “Start Visit” to start the visit. This link is only active fifteen minutes before the scheduled meeting.

### My “Profile” Tab:

The “My Profile Tab” is information about the Facility. It contains the name, address, city, zip, and country.
1. Enter “business name”
2. Enter “address”
3. Enter “city”
4. Enter “state”
5. Enter “zip”
6. Enter “county”
7. Click “update” to update the information

### Visiting Time:

At the scheduled time, the facility wheels the “Visit Me” Cart to the Resident or Resident goes to the Cart. At the scheduled time, the visit begins automatically. The built-in camera on the Cart tracks the Resident with voice tracking, keeping the Resident always framed. At a predetermined end-time of the visit, the system will automatically stop the visit, and the Cart becomes available for the next scheduled appointment.

As will be appreciated by one skilled in the art, aspects may be embodied as a system, method, and/or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the embodiments are described above with reference to flowchart illustrations and/or block diagrams of methods, apparatus (systems) and computer program products according to the embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks. The flowchart and block diagrams in the Figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiment was chosen and described in order to best explain the principles of the embodiments and the practical application, and to enable others of ordinary skill in the art to understand the various embodiments with various modifications as are suited to the particular use contemplated. While the preferred embodiment has been described, it will be understood that those skilled in the art, both now and in the future, may make various improvements and enhancements which fall within the scope of the claims which follow. These claims should be construed to maintain the proper protection for the embodiments first described.

What is claimed is:

1. A system comprising:
an input/output device remote from a first-user; and
a processor programmed to:
receive an input from the first-user at the processor, the input including a request from the first user for a meeting with a second-user;
deliver an output at the input/output device, the output including the request sent to at least one of the second-user and an administrator;
deliver an output from the processor, the output including confirming the meeting to the first-user and at least one of the second-user and the administrator; and
deliver an output at the input/ouput device, the ouput including connecting the first-user with the second-user at the meeting without at least one of the second-user and the administrator interacting with the input/ouput device.

2. The system of claim 1 wherein the processor includes a dashboard accessible by at least one of the first-user, the second-user, and the administrator, and each one of the at least one of the first-user, the second-user, and the administrator access the dashboard according to permissions granted to each.

3. The system of claim 2 wherein the dashboard includes profiles setup for the first-user, the second-user, and the administrator which defines the permissions of each.

4. The system of claim 1 wherein the input/out device used by at least one of the second-user and the administrator is remote from the processor.

5. The system of claim 1 wherein the input/out device is used by at least one of the second-user and the administrator to request a meeting with the first-user with either the second-user and the administrator.

6. The system of claim 1 wherein the processor includes a calendar used to organize the meeting between the first-user and the second-user.

7. The system of claim 1 wherein the meeting starts and finishes without contact between the input/ouput device and at least one of the second-user and the administrator.

8. A method comprising:
submitting a request from a first party over a communications network to a server for a meeting;
receiving the request by at least one of a second party and an administrator over an appliance connected to the commuincations network;
scheduling the meeting by the server after acceptance of the request by at least one of the second party and the administrator; and
connecting the first party with the second party at the accepted meeting via the server without at least one of the second party and the administrator interacting with the appliance.

9. The method of claim 8 further comprising arranging access to the appliance by the administrator for the second party.

10. The method of claim 8 further comprising ending the meeting by the server when the accepted meeting ends without an action by the first party, the second party, and the administrator.

11. A method comprising:
submitting a request from a first party over a communications network to a server for a meeting;
receiving the request by at least one of a second party and an administrator over an appliance connected to the commuincations network;
scheduling the meeting by the server after acceptance of the request by at least one of the second party and the administrator; and
connecting the first party with the second party at the accepted meeting via the server through a single click by at least one the second party and the administrator interacting with the appliance.

12. The method of claim 11 further comprising arranging access to the appliance by the administrator for the second party.

13. The method of claim 11 further comprising ending the meeting by the server when the accepted meeting ends without an action by the first party, the second party, and the administrator.
